(19) United States
(12) Patent Application Publication
(10) Pub. No.: US 2008/0144456 A1
(43) Pub. Date: Jun. 19, 2008

(54) OPTICAL DISC APPARATUS AND OPTICAL DISC RECORDING AND REPRODUCTION METHOD

(75) Inventors: Takahiko Mihara, Tokyo (JP); Tatsuji Ashitani, Tokyo (JP)

Correspondence Address: KNOBBE MARTENS OLSON & BEAR LLP, 2040 MAIN STREET, FOURTEENTH FLOOR, IRVINE, CA, 92614, US

(73) Assignee: Kabushiki Kaisha Toshiba, Tokyo (JP)

(21) Appl. No.: 11/957,306

(22) Filed: Dec. 14, 2007

(30) Foreign Application Priority Data
Dec. 15, 2006 (JP) 2006-338780

(51) Int. Cl. G11B 7/0045

(52) U.S. Cl. 369/47.28

(57) ABSTRACT

To expand a capture range of a PLL circuit when a recording parameter optimal to a disc is decided when a PRML identification system is used. In an optical disc apparatus according to the present invention, the PLL circuit generates a reproduction clock signal based on a reproduction signal. A CPU determines whether a reproduction signal used when test data recorded on an optical disc is reproduced is locked in the PLL circuit or not. A spindle motor control circuit is controlled to change a speed of the disc to be increased when it is determined that the reproduction signal used when the test data is reproduced is not locked in the PLL circuit. The CPU decides a recording parameter and a write strategy correction value calculated on the basis of the reproduction signal used when the test data recorded on the predetermined area of the disc is reproduced.

### BACKGROUND OF THE INVENTION

1. Field of the Invention

The present invention relates to an optical disc apparatus and an optical disc recording and reproduction method. In particular, the invention relates to an optical disc apparatus and an optical disc recording and reproduction method with which recording parameters can be decided in a case of using a PRML identification system.

2. Description of the Related Art

In recent years, such a technology has been proposed for deciding record parameters (for example, a record power, a write strategy, etc.) which are optimal to an individual recordable disc when data is recorded on the recordable optical disc such as a CD (compact Disc)-R/RW, a DVD (Digital Versatile Disc)-R/RW, or an HD (High Definition)-DVD-R/RW. According to the technology, while record parameters (for example, a record power, a write strategy, etc.) are changed, test data is written on trial in a predetermined area of the disc area (PCA (Power Calibration Area)), and the written test data is reproduced to decide the optimal record parameters.

As the technology for deciding the optimal record parameters, for example, a technology for deciding optimal record parameter by using asymmetry (asymmetry property) and jitter of a reproduction signal is known.

Recently, along with a trend of a higher density of the optical discs, in order to secure an S/N ratio and reduce an inter-symbol interference, a PRML (Partial Response and Maximum likelihood) identification system has been adopted. In this PRML identification system, a PR (Partial Response) characteristic in accordance with a recording and reproduction characteristic is used.

A technology with which the optimal record parameters can be decided in the optical disc apparatus which adopts this PRML identification system has been proposed (for example, refer to Japanese Unexamined Patent Application Publication No. 2005-346847).

According to the technology proposed in Japanese Unexamined Patent Application Publication No. 2005-346847, record parameters can be decided while an evaluation value based on a signal evaluation method suitable to the PRML identification system is used as an index. With this configuration, in the optical disc apparatus which adopts the PRML identification system, it is possible to decide the optimal record parameters in a short period of time.

However, according to the technology proposed in Japanese Unexamined Patent Application Publication No. 2005-346847, the record parameters can be decided while the evaluation value based on the signal evaluation method suitable to the PRML identification system is used as the index. Also, not only good quality products but also inferior quality products exist among optical discs of the same type in various optical discs. Even when the record parameters of the optical disc are intended to be decided, such a situation may be generated that a reproduction signal cannot be synchronized (locked) in a PLL (Phase Locked Loop) circuit in some cases.

In particular, in an optical disc in which a higher density is achieved, for example, an HD DVD-R/RW, the minimum mark length is 2 T. A reproduction signal amplitude at the time of recording or reproducing a mark or space of this minimum mark length 2 T is extremely small. Thus, similarly, even when the record parameters of the optical disc are intended to be decided, such a situation may be generated that the reproduction signal cannot be synchronized (locked) in a PLL (Phase Locked Loop) circuit in some cases.

In such a case, it is impossible to measure an asymmetry of the reproduction signal, and also, an evaluation index of the reproduction signal cannot be measured. As a result, there is a problem that the optimal record parameters for this optical disc cannot be decided.

### SUMMARY OF THE INVENTION

The present invention has been made in view of the above and accordingly it is an object of the invention to provide an optical disc apparatus and an optical disc recording and reproduction method with which a capture range of the PLL circuit can be expanded when a record parameter optimal to the disc is decided in a case where a PRML identification system is used.

In order to solve the above-mentioned problems, according to an aspect of the present invention, there is provided an optical disc apparatus, including: a PLL circuit configured to generate a reproduction clock signal based on a reproduction signal; a first determination unit configured to determine whether a reproduction signal used when test data recorded on a predetermined area of a disc is reproduced is locked in the PLL circuit or not; a change unit configured to change a speed of the disc to be increased when it is determined by the first determination unit that the reproduction signal used when the test data recorded on the predetermined area of the disc is reproduced is not locked in the PLL circuit; and a decision unit configured to decide a recording parameter used when user data is recorded on the disc in accordance with an evaluation index of the reproduction signal used when the test data recorded on the predetermined area of the disc is reproduced and a write strategy correction value of the reproduction signal used when the test data recorded on the predetermined area of the disc is reproduced.

In order to solve the above-mentioned problems, according to another aspect of the present invention, there is provided an optical disc recording and reproduction method for an optical disc apparatus including a PLL circuit for generating a reproduction clock signal based on a reproduction signal, the method including: a first determination step of determining whether a reproduction signal used when test data recorded on a predetermined area of a disc is reproduced is locked in the PLL circuit or not; a change step of changing a speed of the disc to be increased when it is determined through a processing in the first determination step that the reproduction signal used when the test data recorded on the predetermined area of the disc is reproduced is not locked in the PLL circuit; and a decision step of deciding a recording parameter used when user data is recorded on the disc in accordance with an evaluation index of the reproduction signal used when the test data recorded on the predetermined area of the disc is reproduced and a write strategy correction value calculated on the basis of the reproduction signal used when the test data recorded on the predetermined area of the disc is reproduced.

In the optical disc apparatus according to the aspect of the present invention, the reproduction clock signal based on the reproduction signal is generated, it is determined whether the reproduction signal used when the test data recorded on the predetermined area of the disc is reproduced is locked in the PLL circuit or not, the speed of the disc is changed to be increased when it is determined that the reproduction signal used when the test data recorded on the predetermined area of the disc is reproduced is not locked in the PLL circuit, and the recording parameter used when user data is recorded on the disc is decided in accordance with the evaluation index of the reproduction signal used when the test data recorded on the predetermined area of the disc is reproduced and the write strategy correction value of the reproduction signal used when the test data recorded on the predetermined area of the disc is reproduced.

In the optical disc recording and reproduction method according to the aspect of the present invention, it is determined whether the reproduction signal used when test data recorded on the predetermined area of the disc is reproduced is locked in the PLL circuit or not, the speed of the disc is changed to be increased when it is determined that the reproduction signal used when the test data recorded on the predetermined area of the disc is reproduced is not locked in the PLL circuit, and the recording parameter used when user data is recorded on the disc is decided in accordance with the evaluation index of the reproduction signal used when the test data recorded on the predetermined area of the disc is reproduced and the write strategy correction value calculated on the basis of the reproduction signal used when the test data recorded on the predetermined area of the disc is reproduced.

According to the present invention, the capture range of the PLL circuit can be expanded when the record parameter optimal to the disc is decided in a case where the PRML identification system is used.

### BRIEF DESCRIPTION OF THE DRAWINGS

FIG. 1 is a block diagram of an internal configuration of an optical disc apparatus according to an embodiment of the present invention;

FIGS. 2A to 2C illustrate reproduction signal amplitudes in a case where test data is recorded or reproduced while a linear velocity of an optical disc is set higher than an appropriate linear velocity;

FIG. 3 is a flowchart for describing a recording parameter decision processing in the optical disc apparatus of FIG. 1;

FIGS. 4A to 4C are explanatory diagrams for describing a write strategy representing a correspondence relation between a recording waveform recorded on the optical disc and a recording signal waveform;

FIG. 5 is an explanatory diagram for describing a calculation method of calculating a write strategy correction value through a DEM arithmetical operation; and

FIG. 6 illustrates an experiment result representing a lock state of a PLL circuit in a case where a conventional recording parameter decision processing or the recording parameter decision processing of FIG. 3 is executed while a pulse width is shifted from an optimal value.

### DESCRIPTION OF THE PREFERRED EMBODIMENTS

Hereinafter, embodiments of the present invention will be described with reference to the drawings.

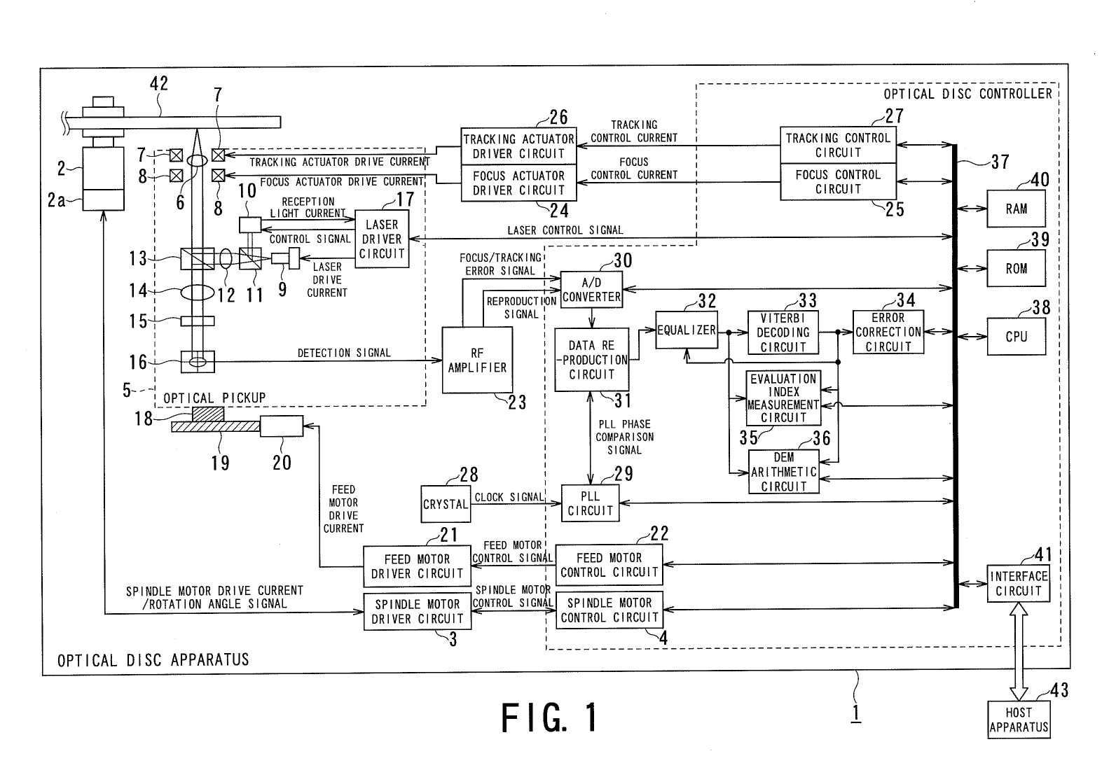

FIG. 1 illustrates a configuration of an optical disc apparatus 1 according to an embodiment of the present invention.

The optical disc apparatus 1 is adapted to perform information recording on an optical disc 42, for example, a DVD (Digital Versatile Disc)-R/RW, a HD (High Definition)-DVD-R/RW, or the like functioning as information recording medium and reproduction with use of a PRML identification system. The optical disc 42 has grooves formed concentrically or spirally. A concave part of the groove is referred to as land, and a convex part thereof is referred to as groove. A circle of the groove or the land is referred to as track. User data is recorded on the optical disc 42 while an intensity-modulated laser beam is emitted along this track (only the groove, or the groove and the land) and record marks are formed. Data reproduction is performed by detecting a change in reflection light intensity due to the record marks on the track while a laser beam with a read power which is weaker the power during the recording is emitted along the track. Deletion of data recorded on a rewritable medium (a DVD-RW, an HD DVD-RW, or the like) is performed through crystallization of a recording layer by emitting a laser beam with an erase power which is stronger than the read power along the track.

The optical disc 42 is rotated and driven by a spindle motor 2. A rotation angle signal is output from a rotary encoder 2a which is provided to the spindle motor 2, to a spindle motor driver circuit 3. When the spindle motor 2 makes one rotation, the rotation angle signal generates, for example, five pulses. With this configuration, a spindle motor control circuit 4 can determine the rotation angle and the number of rotations of the spindle motor 2 on the basis of the rotation angle signal input from the rotary encoder 2a via the spindle motor driver circuit 3. The spindle motor 2 is controlled by the spindle motor control circuit 4.

Recording or reproduction of information with respect to the optical disc 42 is performed by an optical pickup 5. The optical pickup 5 is linked to a feed motor 20 via a gear 18 and a screw shaft 19, and the feed motor 20 is controlled by a feed motor driver circuit 21. As the feed motor 20 is rotated with a feed motor drive current supplied from the feed motor driver circuit 21, the optical pickup 5 is moved in a radius direction of the optical disc 42.

The optical pickup 5 is provided with an objective lens 6 supported by a wire or a plate spring which is not illustrated in the drawing. The objective lens 6 can be moved in a focusing direction (an optical axis direction of the lens) by way of the drive of a focus actuator 8, and also be moved in a tracking direction (a direction perpendicular to the optical axis direction of the lens) by way of the drive of a tracking actuator 7.

A laser driver circuit 17 supplies a write signal to a laser diode (laser light emitting element) 9 at the time of information recording (during mark formation) on the basis of the recording data supplied from a host apparatus 43 via an interface circuit 41. Also, the laser driver circuit 17 supplies a read signal which is smaller than the write signal to the laser diode 9 at the time of information reading.

A front monitor photodiode 10 branches a part of laser light generated by the laser diode 9 at a given ratio by using a half mirror 11, detects the quantity of light, in other words, a reception light signal in proportion to the irradiation power, and supplies the detected reception light signal to the laser driver circuit 17. The laser driver circuit 17 obtains the reception light signal supplied from the front monitor photodiode 10, and controls the laser diode 9 on the basis of the thus obtained reception light signal so that the laser diode 9 emits lights at a laser power (irradiation power) during the reproduction, at a laser power during the recording, and at a laser power during the deletion which are previously set by a CPU 38.

The laser diode 9 emits laser light in accordance with the signal supplied from the laser driver circuit 17. The laser light emitted from the laser diode 9 is emitted onto the optical disc 42 via a collimator lens 12, a half prism 13, and the objective lens 6. The reflection light from the optical disc 42 is guided to an optical detection device 16 via the objective lens 6, the half prism 13, a collective lens 14, and a cylindrical lens 15.

The optical detection device 16 is composed of, for example, four divisional optical detection cells, and adapted to generate a detection signal and output the thus generated detection signal to an RF amplifier 23. The RF amplifier 23 performs a processing on the detection signal supplied from the optical detection device 16. Also, the RF amplifier 23 generates a focus error signal (FE) indicating an error from the just focus, a tracking error signal (TE) indicating an error between the beam spot center of the laser light and the track center, and a reproduction signal (RF) which is a full addition signal of detection signals, and supplies to an A/D converter 30 the focus error signal (FE), the tracking error signal (TE), and the reproduction signal (RF) which have been thus generated.

A focus control circuit 25 generates a focus control signal in accordance with the focus error signal (FE) taken in from the RF amplifier 23 via the A/D converter 30 and supplies the thus generated focus control signal to a focus actuator driver circuit 24. The focus actuator driver circuit 24 supplies a focus actuator drive current for driving the focus actuator 8 to the focus actuator 8 in the focusing direction on the basis of the focus control signal supplied from the focus control circuit 25. With this configuration, a focus servo is conducted so that the laser light regularly has the just focus on the recording layer of the optical disc 42.

A tracking control circuit 27 generates a tracking control signal in accordance with the tracking error signal (TE) taken in from the RF amplifier 23 via the A/D converter 30 and supplies the thus generated tracking control signal to a tracking actuator driver circuit 26. The tracking actuator driver circuit 26 supplies a tacking actuator drive current for driving the tracking actuator 7 to the tracking actuator 7 in the tracking direction on the basis of the tracking control signal supplied from the tracking control circuit 27. With this configuration, a tracking servo is conducted so that the laser always traces the track formed on the optical disc 42.

While such focus servo and tracking servo are conducted, the change in reflection light from the mark (or the bit) formed on the track of the optical disc 42 corresponding to the recorded information reflects the reproduction signal (RF) which is the full addition signal of the detection signals from the optical detection device 16 (the respective optical detection cells). This reproduction signal is an ultraweak analog signal. The reproduction signal is amplified by the RF amplifier 23 and sampled in the A/D converter 30 at a constant frequency, and thereafter supplied to a data reproduction circuit 31. Also, the data reproduction circuit 31 performs corrections on the amplitude and offset of the reproduction signal supplied from the A/D converter 30 and converts the reproduction signal into a signal synchronism with a reproduction clock signal in the PLL (Phase Locked Loop) circuit 29 before being output to an equalizer 32.

The equalizer 32 uses an arbitrary PR characteristic to convert the reproduction signal input from the data reproduction circuit 31 into an equalized reproduction signal close to the arbitrary PR characteristic, and outputs the converted equalized reproduction signal to a Viterbi decoding circuit 33, an evaluation index measurement circuit 35, and a DEM (Detection Error Minimization) arithmetic circuit 36. The Viterbi decoding circuit 33 selects a path having the smallest Euclidean distance to the equalized reproduction signal which is input from the equalizer 32. The Viterbi decoding circuit 33 outputs a code bit sequence corresponding to the selected path to an error correction circuit 34 as decoded data, and also outputs this decoded data to the equalizer 32, the evaluation index measurement circuit 35, and the DEM arithmetic circuit 36 as well.

The evaluation index measurement circuit 35 calculates, for example, PRSNR (Partial Response Signal to Noise Ratio), SbER (Simulated Bit Error Rate), the asymmetry, and the like as the evaluation index of the reproduction signal on the basis of the equalized reproduction signal and the decoded data respectively input from the equalizer 32 and the Viterbi decoding circuit 33, and supplies data related to the calculated PRSNR, SbER, asymmetry and the like to the CPU 38 via the bus 37.

The DEM arithmetic circuit 36 calculates a write strategy correction value that is a correction value of the set write strategy on the basis of the equalized reproduction signal and the decoding data respectively input from the equalizer 32 and the Viterbi decoding circuit 33 and supplies the calculated write strategy correction value to the CPU 38 via the bus 37.

The CPU 38 performs various arithmetic processings on digital signals such as the focus error signal (FE) and the tracking error signal (TE), which have been converted into the digital signals via the A/D converter 30 after being output from the RF amplifier 23 to control the spindle motor control circuit 4, a feed motor control circuit 22, the focus control circuit 25, and the tracking control circuit 27.

In addition, the laser driver circuit 17, a PLL circuit 29, the A/D converter 30, the error correction circuit 34, and other components are controlled by the CPU (central Processing Unit) 38 via the bus 37. The CPU 38 executes various processings while following a program stored in a ROM (Read Only Memory) 39 and a program loaded on a RAM (Random Access Memory) 40 from the ROM 39 as well as operation commands supplied via the interface circuit 41 from the host apparatus 43. The CPU 38 generates various control signals to be supplied to the respective units, thus controlling the optical disc apparatus 1 in an overall manner.

Incidentally, record parameters can be decided while the a evaluation value based on the signal evaluation method suitable to the PRML identification system is used as an index according to the technology proposed in Japanese Unexamined Patent Application Publication No. 2005-346847, the PRML identification system. Also, not only good quality products but also inferior quality products are present among optical discs 42 of the same type in various optical discs 42. Even when the record parameters of the optical disc 42 are intended to be decided, such a situation may be generated that a reproduction signal cannot be synchronized (locked) in a PLL (Phase Locked Loop) circuit 29 in some cases.

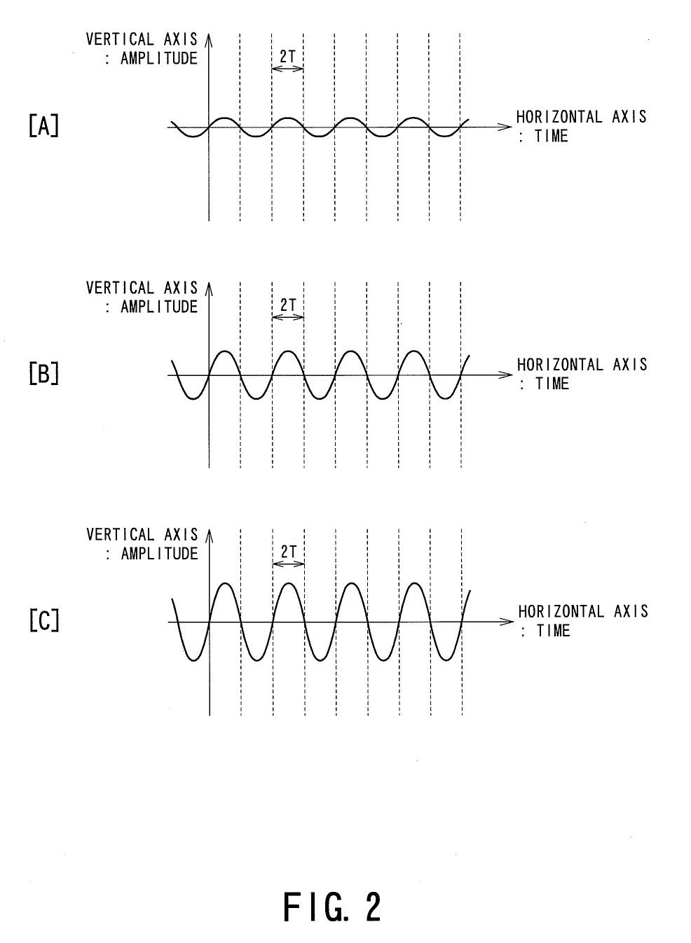

In particular, in the optical disc 42 in which a higher density is achieved, for example, the HD DVD-R/RW, the minimum mark length is 2 T. As illustrated in FIG. 2A, a reproduction signal amplitude at the time of recording or reproducing a mark or space of this minimum mark length 2 T is extremely small. Therefore, even when the recording parameters of the optical disc are intended to be decided, such a situation may be generated that the reproduction signal cannot be synchronized (locked) in the PLL circuit 29 in some cases.

Also, in a case where an initial setting write strategy used for recording user data on the optical disc 42 is not appropriate, a shape of a mark formed on a predetermined area of the optical disc 42 (PCA (Power Calibration Area)) is not satisfactory. For example, the 2 T mark is formed into a 1.8 T mark, a 2.2 T mark, or the like. Similarly, even when the record parameters of the optical disc 42 are intended to be decided, such a situation may be generated that the reproduction signal cannot be synchronized (locked) in the PLL circuit 29 in some cases.

In such a case, it is impossible to measure an asymmetry of the reproduction signals, and also, an evaluation index of the reproduction signal cannot be measured. As a result, there is a problem that the optimal record parameters for this optical disc cannot be decided. With this configuration, the user data cannot be recorded on the optical disc 42.

In view of the above, when it is determined that the reproduction signal cannot be synchronized (locked) in the PLL circuit, the linear velocity (rotation speed) of the optical disc 42 is set higher than the appropriate linear velocity, and the test data can be recorded and reproduced. With this configuration, for example, a space length occupied by the 2 T mark recorded on the optical disc 42 (for example, a period of time during which the laser beam passes through the 2 T mark) becomes longer. In other words, a recording density of the test data to be recorded on the optical disc 42 is decreased while the time axis is kept, and for example, as illustrated in FIGS. 2B and 2C, the reproduction signal amplitude becomes larger. As a result, the S/N ratio of the reproduction signal becomes satisfactory. Even when the mark recorded on the optical disc 42 is short or the write strategy is not appropriate, the reproduction signal can be synchronized (locked) in the PLL circuit. It should be noted that, FIG. 2B illustrates the reproduction signal amplitude in a case where the test data is recorded and reproduced while the linear velocity (rotation speed) of the optical disc 42 is increased to an intermediate velocity, and FIG. 2C illustrates the reproduction signal amplitude in a case where the test data is recorded and reproduced while the linear velocity (rotation speed) of the optical disc 42 is increased to a high velocity.

Hereinafter, a recording parameter decision processing in the optical disc apparatus 1 of FIG. 1 where this method is used will be described.

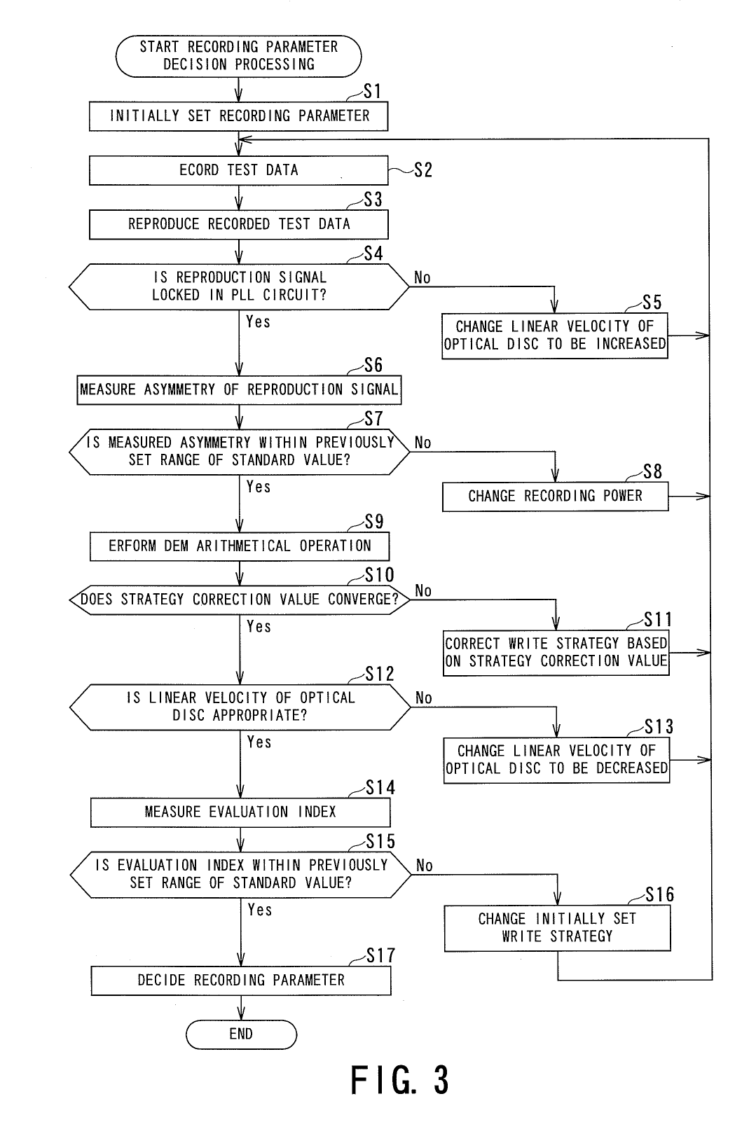

With reference to the flowchart of FIG. 3, the recording parameter decision processing in the optical disc apparatus 1 of FIG. 1. This recording parameter decision processing is previously started when the user data is recorded on the optical disc 42 as the user inserts the optical disc 42 into the optical disc apparatus 1 and operates an operation unit (not illustrated) of the host apparatus 43 to instruct the recording processing start.

In Step S1, the CPU 38 reads out initial values of the recording parameters used when the user data is recorded on the optical disc 42 (for example, the recording power, the write strategy, etc.) from the ROM 39, and performs the initial setting of the recording parameters used for recording the user data on the optical disc 42 on the basis of the read initial values of the recording parameters.

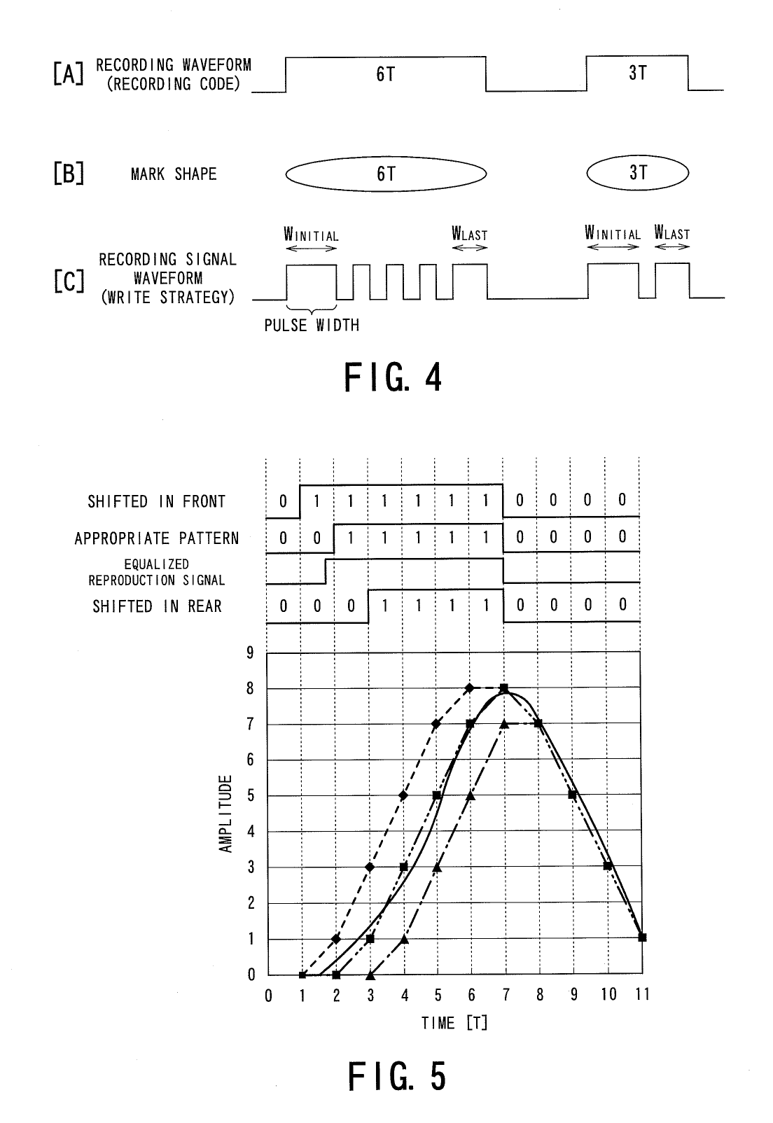

Herein, with reference to FIGS. 4A to 4C, a description will be given of the write strategy representing a correspondence relation between a recording waveform recorded on the optical disc 42 and a recording signal waveform.

For example, as illustrated in FIG. 4A, a recording waveform (recording code) is classified into, for example, “6 T” (a recording waveform in which “1” is continued by six bits) or “3 T” (a recording waveform in which “1” is continued by three bits). At this time, for example, the recording code of “6 T” is recorded on the optical disc 42, even if the optical disc 42 is irradiated with a laser simply having a pulse width of 6 T, a heat pool or the like is generated on a disc surface of the optical disc 42 at the time of recording. Thus, a satisfactory mark shape “6 T” illustrated in FIG. 4B cannot be formed. In view of the above, for example, as illustrated in FIG. 4C, the optical disc 42 is irradiated with a laser of a multi pulse train composed of a plurality of divided pulses. With this configuration, no influence from the heat pool or the like generated on a disc surface of the optical disc 42 is developed at the time of recording, and accordingly a satisfactory mark shape can be formed.

A composition method of composing the laser by using the plurality of divided pulses in this way is referred to as “write strategy”. For example, when the write strategy is set, the number of division pulses to be divided, the pulse width of the respective division pulses, and the like are set.

It should be noted that the optimal write strategy for forming the satisfactory mark shape on the optical disc 42 differs depending on the code sequence such as “6 T” or “3 T” but also slightly differs depending on a type or a material of the optical disc 42 which functions as the recording medium. For that reason, in order to improve the recording quality (recording integrity), it is necessary to decide the optimal write strategy in accordance with the respective optical discs 42.

In Step S2, the CPU 38 controls, via the bus 37, the optical pickup 5, the RF amplifier 23, the focus control circuit 25, the tracking control circuit 27, and the like, and uses the initially set recording parameters to perform the recording operation on a predetermined area of the optical disc 42 (PCA (Power Calibration Area)). With this configuration, by using the initially set recording parameters, the predetermined test data is recorded on the optical disc 42.

In Step S3, the CPU 38 controls the optical pickup 5, the RF amplifier 23, the focus control circuit 25, and the tracking control circuit 27 via the bus 37, and uses the initially set recording parameters to perform the reproduction operation on the recorded test data.

In Step S4, the CPU 38 reads out a register (not illustrated) of the PLL circuit 29 and determine whether the reproduction signal is locked (synchronized) in the PLL circuit 29 or not (in other words, whether the reproduction signal is appropriately generated or not) when the recorded test data is reproduced with the initially set recording parameters.

For example, when the reproduction signal is appropriately locked in the PLL circuit 29, the register (not illustrated) of the PLL circuit 29 indicates 1, and when the reproduction signal is not appropriately locked in the PLL circuit 29, the register (not illustrated) of the PLL circuit 29 indicates 0.

In Step S4, when it is determined that the reproduction signal is not locked (not synchronized) in the PLL circuit 29 (in other words, the reproduction signal is not appropriately generated), the CPU 38 controls the spindle motor control circuit 4 and the like in Step S5, and changes the linear velocity (rotation speed) of the optical disc 42 from an appropriate velocity to, for example, a high velocity.

After that, the process returns to Step S2 and the process in Step 2 and subsequent steps is repeatedly executed. That is, through the process in Steps S2 and S3, the recording and reproduction of the test data are performed in a state where the linear velocity (rotation speed) of the optical disc 42 is increased from the appropriate linear velocity, for example, to the high linear velocity. In Step S4, it is determined whether the reproduction signal is locked in the PLL circuit 29 or not at the time of the test recording and reproduction.

As described above, when the test data is recorded and reproduced at the linear velocity (rotation speed) of the optical disc 42 is set higher than the appropriate linear velocity, for example, the high linear velocity, a space length occupied by the mark recorded on the optical disc 42 (for example, a period of time during which the laser beam passes through the 2 T mark) becomes longer, in other words, the recording density is decreased. Then, for example, as illustrated in FIG. 2C, the reproduction signal amplitude becomes larger. As a result, the S/N ratio of the reproduction signal becomes satisfactory. Even when the mark recorded on the optical disc 42 is short or the write strategy is not appropriate, the reproduction signal can be easily synchronized (locked) in the PLL circuit.

Then, until it is determined that the reproduction signal is locked in the PLL circuit 29, the process in Steps S2 to 5S is repeatedly executed, thereby increasing the linear velocity (rotation speed) of the optical disc 42.

It should be noted that even after the recording and the reproduction are performed while the linear velocity (rotation speed) of the optical disc 42 is increased from the appropriate linear velocity to the high linear velocity, for example, if the reproduction signal cannot still locked in the PLL circuit 29, in the process of Step S5, the linear velocity (rotation speed) of the optical disc 42 may be changed to be further increased from the high linear velocity.

Of course, in a case where the linear velocity of the optical disc 42 is increased, the linear velocity may be gradually increased from the velocity the appropriate linear velocity to the intermediate velocity and then to the high velocity, or the linear velocity of the optical disc 42 may be increased in more stepwise.

In Step S4, when it is determined that the reproduction signal is locked (synchronized) in the PLL circuit 29 (in other words, the reproduction clock signal is appropriately generated), the CPU 38 controls the data reproduction circuit 31, the equalizer 32, the Viterbi decoding circuit 33, and the evaluation index measurement circuit 35 in Step S6 to measure the asymmetry of the reproduction signals at the time of the recording and reproduction of the test data.

To be more specific, the equalizer 32 uses an arbitrary PR characteristic to convert the reproduction signal input from the data reproduction circuit 31 into the equalized reproduction signal close to the arbitrary PR characteristic, and outputs the converted equalized reproduction signal to the Viterbi decoding circuit 33 and the evaluation index measurement circuit 35. The Viterbi decoding circuit 33 selects a path having the smallest Euclidean distance to the equalized reproduction signal which is input from the equalizer 32, and outputs a code bit sequence corresponding to the selected path to the equalizer 32 and the evaluation index measurement circuit 35 as the decoded data.

The evaluation index measurement circuit 35 calculates (measures), on the basis of the equalized reproduction signal and the decoded data respectively input from the equalizer 32 and the Viterbi decoding circuit 33, the asymmetry as an evaluation index of the reproduction signal, and supplies data related to the calculated (measured) asymmetry to the CPU 38 via the bus 37.

In Step S7, the CPU 38 obtains the data related to the asymmetry supplied from the evaluation index measurement circuit 35, and determines whether the measured asymmetry of the reproduction signals is within a range of a predetermined standard value or not on the basis of the thus obtained data related to the asymmetry of the reproduction signals.

In Step S7, when it is determined that the measured asymmetry of the reproduction signals is not within the range of the predetermined standard value, the CPU 38 changes the set value of the recording power included in the initially set recording parameters in Step S8 so that the asymmetry of the reproduction signals is within the range of the predetermined standard value.

After that, the process returns to Step S2 and the process in Step 2 and subsequent steps is repeatedly executed. That is, through the process in Steps S2 and S3, the test data is recorded and reproduced in a state where the set value of the recording power among the initially set recording parameters is changed, and thereafter the process in Step S4 and subsequent steps is executed. Then, in Step S7, it is determined again whether the measured asymmetry of the reproduction signal is within the range of the predetermined standard value or not.

With this configuration, until the asymmetry of the reproduction signal is within the range of the predetermined standard value, the process in Steps S2 to S8 is repeatedly executed (for example, repeatedly executed by 2, 3, or more times). In order that the asymmetry of the reproduction signal is within the range of the predetermined standard value, the set value of the recording power included in the initially set recording parameters is changed.

In Step S7, when it is determined that the measured asymmetry of the reproduction signal is within the range of the predetermined standard value, the CPU 38 controls the data reproduction circuit 31, the equalizer 32, the Viterbi decoding circuit 33, the evaluation index measurement circuit 35, and the DEM arithmetic circuit 36 to perform a DEM arithmetical operation.

To be more specific, in accordance with the control of the CPU 38, the DEM arithmetic circuit 36 calculates a strategy correction value that is a correction value of the initially set write strategy on the basis of the equalized reproduction signal and the decoding data respectively input from the equalizer 32 and the Viterbi decoding circuit 33.

For example, as illustrated in FIG. 5, the DEM arithmetic circuit 36 calculates the write strategy correction value by calculating a difference in Euclidean distances among the equalized reproduction signal, an appropriate data pattern, a front shift data pattern which is shifted in front with respect to the appropriate data pattern, and a rear shift data pattern which is shifted in rear with respect to the appropriate data pattern.

The DEM arithmetic circuit 36 supplies the calculated write strategy correction value to the CPU 38 via the bus 37.

In Step S10, the CPU 38 obtains the write strategy correction value supplied from the DEM arithmetic circuit 36 and determines whether the thus obtained write strategy correction value converges to a predetermined value or not. In Step S10, when it is determined that the thus obtained write strategy correction value does not converge to the predetermined value, the CPU 38 corrects the initially set write strategy on the basis of the thus obtained write strategy correction value in Step S11.

After that, the process returns to Step S2 and the process in Step 2 and subsequent steps is repeatedly executed. That is, through the process in Steps S2 and S3, the test data is recorded and reproduced in a state where the write strategy among the initially set recording parameters is corrected (reflected), and thereafter the process in Step S4 and subsequent steps is executed. Then, in Step S10, it is determined again whether the thus obtained write strategy correction value converges to the predetermined value or not.

With this configuration, the DEM arithmetic circuit 36 corrects the write strategy on the basis of the calculated write strategy correction value repeatedly until the calculated write strategy correction value converges to the predetermined value.

In Step S10, when it is determined that the thus obtained write strategy correction value converges to the predetermined value, the CPU 38 determines in step S12 whether the current linear velocity (rotation speed) of the optical disc 42 is the appropriate linear velocity (rotation speed) or not (in other words, the CPU 38 determines whether the current linear velocity (rotation speed) of the optical disc 42 is within an appropriate predetermined range of the linear velocity (rotation speed) or not).

To be more specific, in Step S5, in a case where the linear velocity of the optical disc 42 is changed, for example, to be increased to the high linear velocity so that the reproduction signal is locked in the PLL circuit 29, it is determined that the current linear velocity (rotation speed) of the optical disc 42 is not the appropriate linear velocity (rotation speed).

In Step S12, when it is determined that the current linear velocity (rotation speed) of the optical disc 42 is not the appropriate linear velocity (rotation speed) (in other words, when it is determined that the current linear velocity (rotation speed) of the optical disc 42 is increased higher than the appropriate linear velocity), the CPU 38 controls the spindle motor control circuit 4 and the like in Step S13 to change the linear velocity (rotation speed) of the optical disc 42 to be decreased from the current high linear velocity, for example, to the appropriate linear velocity.

With this configuration, the linear velocity (rotation speed) of the optical disc 42 is decreased from the high linear velocity to the appropriate linear velocity, for example.

After that, the process returns to Step S2 and the process in Step 2 and subsequent steps is repeatedly executed. That is, through the process in Steps S2 and S3, the test data is recorded and reproduced in a state where the linear velocity (rotation speed) of the optical disc 42 is changed, for example, from the high linear velocity to the appropriate linear velocity, and the process in Step S4 and subsequent steps is executed. After that, in Step S12, it is determined again whether the current linear velocity (rotation speed) of the optical disc 42 is the appropriate linear velocity (rotation speed) or not.

In Step S12, when it is determined that the current linear velocity (rotation speed) of the optical disc 42 is the appropriate linear velocity (rotation speed), the CPU 38 controls the data reproduction circuit 31, the equalizer 32, the Viterbi decoding circuit 33, and the evaluation index measurement circuit 35 in Step S14 and measures the evaluation index of the reproduction signal at the time of the recording and reproduction of the test data.

To be more specific, the equalizer 32 uses an arbitrary PR characteristic to convert the reproduction signal input from the data reproduction circuit 31 into the equalized reproduction signal close to the arbitrary PR characteristic, and outputs the converted equalized reproduction signal to the Viterbi decoding circuit 33 and the evaluation index measurement circuit 35. The Viterbi decoding circuit 33 selects a path having the smallest Euclidean distance to the equalized reproduction signal which is input from the equalizer 32, and outputs a code bit sequence corresponding to the selected path to the equalizer 32 and the evaluation index measurement circuit 35 as the decoded data.

The evaluation index measurement circuit 35 calculates, on the basis of the equalized reproduction signal and the decoded data respectively input from the equalizer 32 and the Viterbi decoding circuit 33, for example, PRSNR or SbER as the evaluation index of the reproduction signal, and supplies data related to the calculated PRSNR or SbER to the CPU 38 via the bus 37.

In Step S15, the CPU 38 determines whether the calculated evaluation index of the reproduction signal is within a previously set range of a standard value or not on the basis of the data related to PRSNR and SbER supplied from the evaluation index measurement circuit 35. In Step S15, when it is determined that the evaluation index of the reproduction signal is not within the previously set range of the standard value, in order that the evaluation index of the reproduction signal is within a previously set range of the standard value is within the previously set range of the standard value, the CPU 38 changes the initially set write strategy in Step S16. With this configuration, the write strategy used for recording the user data on the optical disc 42 can be changed to the write strategy optimal to the optical disc 42.

After that, the process returns to Step S2 and the process in Step 2 and subsequent steps is repeatedly executed. That is, in through the process in Steps S2 and S3, the test data is recorded and reproduced with use of the write strategy changed from the initially set write strategy, and the process in Step S4 and subsequent steps is executed. After that, in Step S15, it is determined again whether the calculated evaluation index of the reproduction signal is within the previously set range of the standard value or not.

With this configuration, until the calculated evaluation index of the reproduction signal is within the previously set range of the standard value, the process in Steps S2 to S16 is repeatedly executed so that the write strategy used for recording the test data on the optical disc 42 is changed.

In Step S15, when it is determined that the calculated evaluation index of the reproduction signal is within the previously set range of the standard value, the CPU 38 sets the recording parameters used for recording the user data on the optical disc 42 as the current recording parameters (the recording power and the write strategy) in Step S17.

In other words, as the process in Steps S2 to S16 is repeatedly executed, the current recording power in which the recording power among the initially set recording parameters is changed and the current write strategy which is corrected on the basis of the write strategy correction value (or, furthermore, the write strategy which is changed so that the evaluation index of the reproduction signal is within the previously set range of the standard value) are decided as the recording parameters used for recording the user data on the optical disc 42.

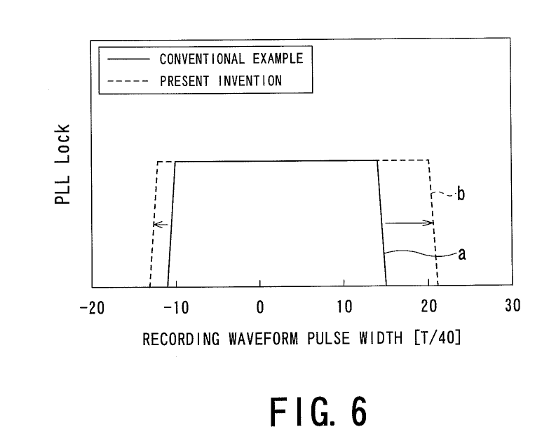

FIG. 6 illustrates an experiment result representing the lock state in the PLL circuit 29 in a case where the conventional recording parameter decision processing or the recording parameter decision processing of FIG. 3 is executed while, for example, the pulse width is shifted from the optimal value (optimal pulse width) in the optimal write strategies used for recording the user data on a certain one optical disc 42. A horizontal axis of FIG. 6 indicates a pulse width of the recording signal waveform (T/40) and a vertical axis thereof indicates the lock state of the reproduction signal in the PLL circuit 29.

It should be noted that in the case of the example illustrated in FIG. 6, the test data is recorded and reproduced on the optical disc 42 of a single layer type HD DVD-R at 1× speed.

For example, a pulse width Wᵢₙᵢₜᵢₐₗ of an initial pulse and a pulse width Wₗₐₛₜ of a last pulse illustrated in FIG. 2C are gradually shifted in the expanding direction and the narrowing direction from the optimal value (optimal pulse width). At this time, for example, as illustrated in a solid line a of FIG. 6, in a case where the conventional recording parameter decision processing is executed, only the reproduction signal can be locked (synchronized) in the PLL circuit 29 until the pulse widths are shifted in the expanding direction by (16/40) T and the narrowing direction by (−12/40) T. In contrast, as illustrated in a broken line b of FIG. 6, in a case where the recording parameter decision processing of FIG. 3 is executed, the reproduction signal can be locked (synchronized) in the PLL circuit 29 until the pulse widths are shifted in the expanding direction by (22/40) T and the narrowing direction by (−14/40) T. That is, it is possible to expand the capture range in which the reproduction signal can be locked in the PLL circuit 29.

According to the embodiments of the present invention, when the recording parameters optimal to the optical disc 42 are decided, it is determined whether the reproduction signal is locked in the PLL circuit 29 or not. When it is determined that the reproduction signal is not locked in the PLL circuit 29, the linear velocity of the optical disc 42 is changed to be increased from the appropriate linear velocity, and the recording and reproduction of the test data are performed in a state where the linear velocity (rotation speed) of the optical disc 42 is increased from the appropriate linear velocity, for example, to the high linear velocity. Thus, it is possible to determine again whether the reproduction signal is locked in the PLL circuit 29 or not at the time of the test recording and reproduction.

Also, after that, when it is determined that the reproduction signal is locked in the PLL circuit 29, the asymmetry of the reproduction signal in a case where the recorded test data is reproduced on a predetermined area of the optical disc 42 (PCA area) is measured. When the measured asymmetry of the reproduction signal is not within the range of the predetermined standard value, in order that the measured asymmetry of the reproduction signal is within the range of the predetermined standard value, it is possible to change the recording power among the recording parameters.

Furthermore, the DEM arithmetical operation is performed on the basis of the equalized reproduction signal and the decoding data, the write strategy correction value that is a correction value of the set write strategy is calculated, and when the calculated write strategy correction value does not converge to the predetermined value, the initially set write strategy can be corrected on the basis of the write strategy correction value.

Then, after that, it is determined whether the current linear velocity of the optical disc 42 is the appropriate linear velocity or not, and when it is determined that the current linear velocity of the optical disc 42 is not the appropriate linear velocity, the linear velocity of the optical disc 42 is changed to be decreased to the appropriate linear velocity. The test data is recorded and reproduced in a state where the linear velocity (rotation speed) of the optical disc 42 is decreased to the appropriate linear velocity and also the evaluation index is measured, the recording parameters used for recording the user data on the optical disc 42 can be decided as the current recording parameters (the recording power and the write strategy).

With this configuration, it is possible to expand the capture range of the PLL circuit 29 for deciding the recording parameters optimal to the optical disc 42 in a case where the PRML identification system is used. As a result, the measurement range for the asymmetry of the reproduction signal can be expanded, and the application range of the DEM arithmetical operation can be expanded. Therefore, in a case where the PRML identification system is used, it is possible to decide the recording parameters optimal to the optical disc 42 with certainty. Therefore, the recording quality (recording integrity) in a case where the user data is recorded on the optical disc 42 can be improved.

It should be noted that a series of processings described according to the embodiments of the present invention can be executed by software but also executed by hardware.

In addition, according to the embodiments of the present invention, such an example has been described that the steps of the flowchart are processed in a time series following the description order, but the steps may not be necessarily executed in a time series. The present invention also encompasses a process in which the steps are executed in parallel or individually.

What is claimed is:

1. An optical disc apparatus, comprising:
a PLL circuit configured to generate a reproduction clock signal based at least in part on a reproduction signal, wherein said reproduction signal is used when test data recorded on a predetermined area of a disc is reproduced;
a first determination unit configured to determine whether the reproduction signal is locked in the PLL circuit or not;
a change unit configured to increase a speed of the disc when it is determined by the first determination unit that the reproduction signal is not locked in the PLL circuit; and
a decision unit configured to decide a recording parameter used when user data is recorded on the disc based at least in part on an evaluation index of the reproduction signal and further configured to decide a write strategy correction value based at least in part on the reproduction signal.

2. The optical disc apparatus according to claim 1, further comprising a second determination unit configured to determine whether the speed of the disc is within a predetermined range or not, wherein when it is determined by the second determination unit that the speed of the disc is not within the predetermined range, the change unit is configured to change the speed of the disc into a speed within the predetermined range.

3. An optical disc recording and reproduction method for an optical disc apparatus including a PLL circuit for generating a reproduction clock signal based on a reproduction signal, the method comprising:
determining whether or not a reproduction signal used when test data recorded on a predetermined area of a disc is reproduced is locked in the PLL circuit;
increasing a speed of the disc when it is determined that the reproduction signal is not locked in the PLL circuit; and
deciding a recording parameter used when user data is recorded on the disc based at least in part on an evaluation index of the reproduction signal and further deciding a write strategy correction value based at least in part on the reproduction signal.
